(19) United States
(12) Patent Application Publication
(10) Pub. No.: US 2012/0260058 A1
(43) Pub. Date: Oct. 11, 2012

(54) MEMORY MANAGEMENT APPARATUS, MEMORY MANAGEMENT METHOD, AND CONTROL PROGRAM

(76) Inventors: Yasuhiro Matsuzaki, Tokyo (JP); Hiroki Kaminaga, Kanagawa (JP); Hiroki Nagahama, Tokyo (JP); Kazumi Sato, Kanagawa (JP)

(21) Appl. No.: 13/428,793

(22) Filed: Mar. 23, 2012

(30) Foreign Application Priority Data
Apr. 8, 2011 (JP) 2011-086306

(51) Int. Cl. G06F 12/02

(52) U.S. Cl. 711/171; 711/E12.002

(57) ABSTRACT

A memory manager secures memory areas according to requests from programs and sets ranks designated by the programs to the secured memory areas. The memory manager selects a memory area released on the basis of the rank of each memory area, from the secured memory areas, when an available capacity of a main storage device is insufficient. The memory manager releases the selected memory area and secures a new memory area. The present disclosure can be applied to an embedded apparatus.

### BACKGROUND

The present disclosure relates to a memory management apparatus, a memory management method, and a control program, and more particularly, to a memory management apparatus, a memory management method, and a control program that are suitable for securing and releasing a memory area.

In the related art, technology for selecting a process having low priority or a process having a long waiting time until next execution and releasing a memory area allocated to the selected process when an available memory capacity is insufficient has been suggested (for example, refer to Japanese Laid-Open Patent Publication No. 2000-215099).

In addition, in the related art, technology for performing page stealing from a job having a low degree of importance and allocating real pages of a memory to a job having a high degree of importance when the real pages of the memory are insufficient has been suggested (for example, refer to Japanese Laid-Open Patent Publication No. 2002-244869).

### SUMMARY

However, according to the technology disclosed in Japanese Laid-Open Patent Publication No. 2000-215099 or Japanese Laid-Open Patent Publication No. 2002-244869, the process or job from which the memory area is released is compulsorily terminated. For this reason, in a system in which a plurality of processes or jobs operate in cooperation with each other, the system may operate abnormally.

According to the present disclosure, when an available capacity of a storage device is insufficient, areas of the storage device can be released and new areas can be secured, while abnormality is suppressed from occurring in a system or an apparatus.

According to an embodiment of the present disclosure, there is provided a memory management apparatus which includes a memory area allocating unit that secures areas of a storage device according to requests from programs and sets ranks designated by the programs to the secured areas, a memory area selecting unit that selects an area released on the basis of the rank of each area from the secured areas when an available capacity of the storage device is insufficient, and a memory area releasing unit that releases the selected area.

The memory area selecting unit may select an area to be released from areas having ranks lower than a rank of a newly secured area.

The memory area selecting unit may select an area having the lowest rank among the areas having ranks lower than the rank of the newly secured area as a released area.

The ranks may be previously set to each program, and the memory area selecting unit may select an area allocated to the program having the lowest rank among the areas having the lowest rank as the released area when there are a plurality of areas having the lowest rank.

The memory area selecting unit may not secure a new area when there is no area having a rank lower than the rank of the newly secured area.

The ranks may be previously set to each program, and the memory area releasing unit may compulsorily terminate at least one of the programs having ranks lower than the ranks of the programs having requested securing of the areas when there is no area having a rank lower than the rank of the newly secured area.

The memory area allocating unit may change the ranks of the areas allocated to the programs according to the requests from the programs.

According to another embodiment of the present disclosure, there is provided a memory management method which includes securing areas of a storage device according to requests from programs and setting ranks designated by the programs to the secured areas, selecting an area released on the basis of the rank of each area from the secured areas when an available capacity of the storage device is insufficient, and releasing the selected area.

According to another embodiment of the present disclosure, there is provided a control program for causing a computer to execute a process including securing areas of a storage device according to requests from programs and setting ranks designated by the programs to the secured areas, selecting an area released on the basis of the rank of each area from the secured areas when an available capacity of the storage device is insufficient, and releasing the selected area.

In one embodiment of the present disclosure, the areas of the storage device are secured according to the requests from the programs, the ranks designated by the programs are set to the secured areas, the area released on the basis of the rank of each area is selected from the secured areas when the available capacity of the storage device is insufficient, and the selected area is released.

According to the embodiments of the present disclosure described above, when the available capacity of the storage device is insufficient, areas of the storage device can be released and new areas may be secured.

According to embodiments of the present disclosure described above, when an available capacity of a storage device is insufficient, areas of the storage device can be released and new areas can be secured, while abnormality is suppressed from occurring in a system or an apparatus.

### BRIEF DESCRIPTION OF THE DRAWINGS

FIG. 1 is a diagram showing an outline of the present disclosure;

FIG. 2 is a block diagram showing an embodiment of an information processing system to which the present disclosure is applied;

FIG. 3 is a block diagram showing a configuration example of functions of a memory manager;

FIG. 4 is a flowchart showing a memory area securing request process;

FIG. 5 is a flowchart showing a first embodiment of a memory area securing process;

FIG. 6 is a diagram showing a specific example of the first embodiment of the memory area securing process;

FIG. 7 is a diagram showing a specific example of the first embodiment of the memory area securing process;

FIG. 8 is a flowchart showing a second embodiment of the memory area securing process;

FIG. 9 is a flowchart showing a third embodiment of the memory area securing process;

FIG. 10 is a flowchart showing a fourth embodiment of the memory area securing process; and

FIG. 11 is a flowchart showing a memory access process.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Hereinafter, embodiments to carry out the present disclosure will be described. The description will be given in the following order.

### 1. Embodiments

### 2. Modifications

### 1. Embodiments

### [Outline of the Present Disclosure]

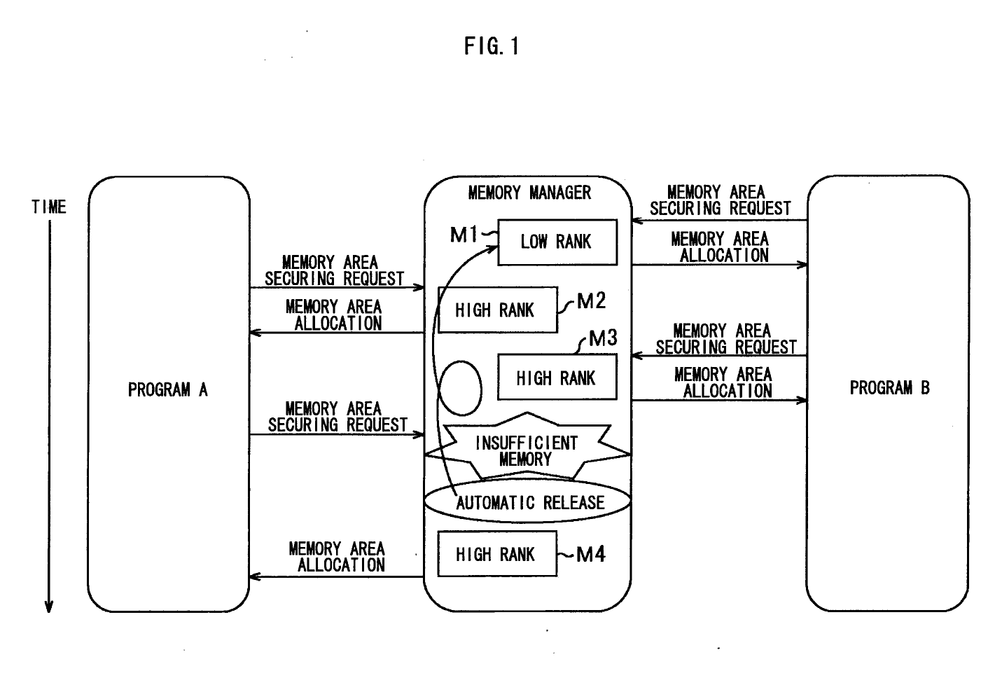

First, the outline of the present disclosure will be described with reference to FIG. 1. A longitudinal direction in the drawings shows a time axis.

A program A and a program B are programs that are executed by an arithmetic processing device such as a central processing unit (CPU). A memory manager is provided as a part of functions of an operating system (OS) and executes processes for securing and releasing memory areas allocated to the program A and the program B.

For example, when the programs A and B request the memory manager to secure the memory areas, the programs designate ranks of the secured memory areas. The memory manager secures the memory areas according to the requests from each program and sets the designated ranks to the secured memory areas.

The rank of each of the memory areas is set on the basis of a degree of importance in which an intended purpose of each memory area is considered. For example, ranks of memory areas that hold data that is indispensable to a process of an entire system or data which it is difficult to reproduce at the time of erasure are set high. Meanwhile, ranks of memory areas that temporarily hold data to realize a high-speed process, for example, a memory area that holds page cache data of a web browser and a memory area that caches data read from a file, are set low. In addition, memory areas that hold data that is easily recalculated are set to have low ranks.

In an example of FIG. 1, first, a memory area M1 that has a low rank may be allocated by the request from the program B. Next, a memory area M2 that has a high rank may be allocated by the request from the program A. Next, a memory area M3 that has a high rank may be allocated by the request from the program B. When the program A requests to secure a memory area M4 having a high rank, if an available memory capacity is insufficient, the memory area M1 that has a rank lower than the rank of the memory area M4 is automatically released. As a result, a problem of the insufficient memory capacity is resolved and the memory area M4 is secured.

As such, in the present disclosure, when the memory area is secured by the request from the program, the rank of the secured memory area is set. When the memory capacity is insufficient, the memory area that has a low rank is preferentially released.

Thereby, a situation in which a memory area holding important data is released and a system or an apparatus operates abnormally can be prevented from occurring.

### [Configuration Example of Information Processing System]

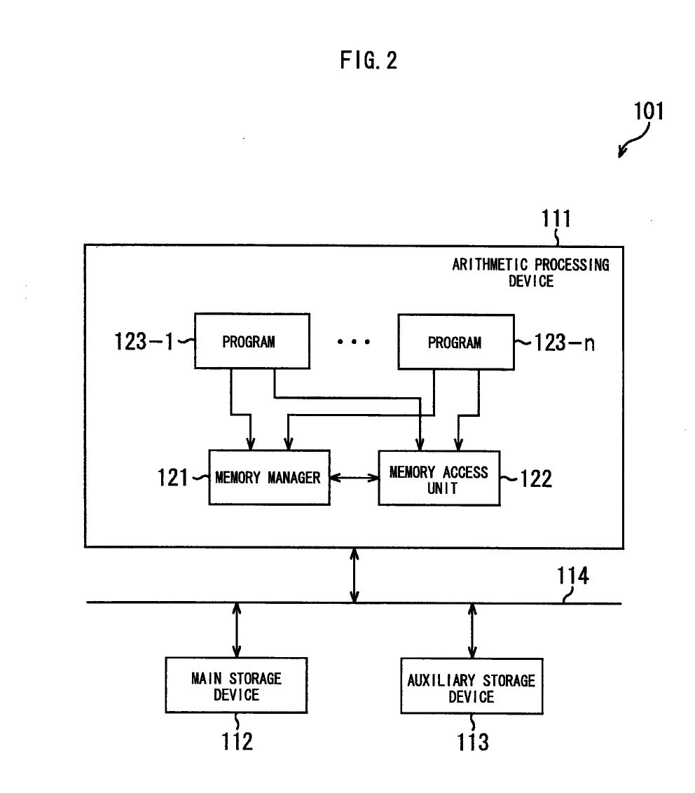

FIG. 2 is a block diagram showing an embodiment of an information processing system 101 to which the present disclosure is applied.

The information processing system 101 is a system that can be applied to various embedded apparatuses such as a television receiver or a mobile phone, a computer, and the like.

The information processing system 101 is configured to include an arithmetic processing device 111, a main storage device 112, and an auxiliary storage device 113. The arithmetic processing device 111, the main storage device 112, and the auxiliary storage device 113 are mutually connected through a bus 114.

The arithmetic processing device 111 includes, for example, a CPU.

The main storage device 112 includes, for example, a random access memory (RAM).

The auxiliary storage device 113 includes a storage device, such as a read only memory (ROM), a hard disk drive, and a flash memory, which has a capacity larger than that of the main storage device 112 and an access speed lower than that of the main storage device 112.

A configuration example of software of the arithmetic processing device 111 will be described.

A memory manager 121 and a memory access unit 122 are provided as parts of functions of an OS executed by the arithmetic processing device 111.

The memory manager 121 controls arrangement of programs or data on the auxiliary storage device 113 with respect to the main storage device 112 and securing and releasing of areas (memory areas) of the main storage device 112, according to requests from programs 123-1 to 123-n. The memory manager 121 sets ranks of the memory areas secured according to the requests from the programs 123-1 to 123-n. Hereinafter, the ranks of the memory areas are classified into ranks of three steps of high, middle, and low. The memory manager 121 notifies programs of request sources of the processing results with respect to the requests from the programs 123-1 to 123-n.

The memory manager 121 generates and updates information (hereinafter referred to as a memory map) that indicates states of the memory areas secured in the main storage device 112 and stores the information in the main storage device 112. The memory map includes information that indicates a position, a size, and a rank of each memory area secured in the main storage device 112, a program 123 to which each memory area is allocated and a rank (to be described below) thereof.

The memory manager 121 compulsorily terminates the programs 123-1 to 123-n, for example, when it is difficult to secure the memory areas.

According to the requests from the programs 123-1 to 123-n, the memory access unit 122 reads designated data from the main storage device 112 using the memory map and delivers the read data to the programs of the request sources. According to the requests from the programs 123-1 to 123-n, the memory access unit 122 writes the designated data on the main storage device 112 using the memory map and notifies the programs of the request sources of the written result.

The memory manager 121 and the memory access unit 122 cooperatively operate while exchanging data with each other.

The programs 123-1 to 123-n include, for example, application programs to cause the arithmetic processing device 111 to realize predetermined functions. The ranks according to priorities of processes that are executed by the programs 123-1 to 123-n are set to the programs 123-1 to 123-n.

The ranks of the programs 123-1 to 123-n are set on the basis of the priorities of the processes executed by each program. For example, the ranks of the programs that need to be preferentially processed may be set high and the ranks of the programs that may be processed late may be set low.

Hereinafter, the ranks of the programs 123-1 to 123-n are classified into ranks of three steps of high, middle, and low. Hereinafter, when the programs 123-1 to 123-n do not need to be individually distinguished, the programs are simply called the programs 123.

### [Configuration Example of Functions of the Memory Manager 121]

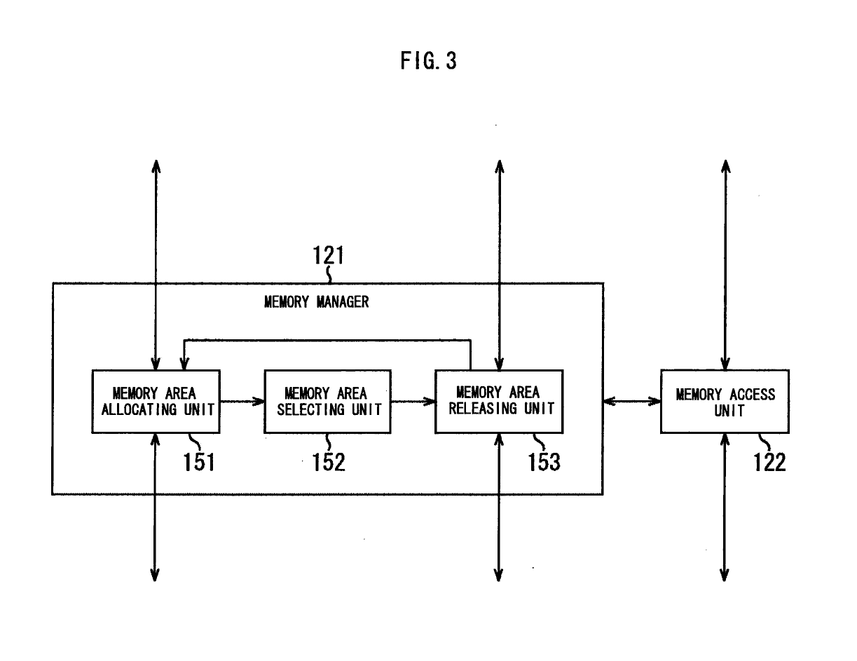

Next, a configuration example of functions of the memory manager 121 will be described with reference to FIG. 3.

The memory manager 121 is configured to include a memory area allocating unit 151, a memory area selecting unit 152, and a memory area releasing unit 153.

The memory area allocating unit 151 secures an area (memory area) of the main storage device 112 according to the request from the program 123 and notifies the program 123 of a request source of the secured result. When the available capacity of the main storage device 112 is insufficient, the memory area allocating unit 151 notifies the memory area selecting unit 152 of information indicating that the available capacity of the main storage device 112 is insufficient, a rank of the securing requested memory area, and a rank of the program 123 of the request source. The memory area allocating unit 151 controls arrangement (swap-in) of programs and data on the auxiliary storage device 113 with respect to the main storage device 112. In addition, the memory area allocating unit 151 updates the memory map that is stored in the main storage device 112, according to securing of the memory area or executing of the swap-in.

When the memory area allocating unit 151 notifies of insufficiency of the available capacity of the main storage device 112, the memory area selecting unit 152 selects a released memory area on the basis of the memory map. The memory area selecting unit 152 notifies the memory area releasing unit 153 of the selected memory area.

The memory area releasing unit 153 releases the memory area that is selected by the memory area selecting unit 152 and notifies the memory area allocating unit 151 that the memory area is released. The memory area releasing unit 153 releases the memory area according to the request from the program 123 and notifies the program 123 of the request source of the released result. The memory area releasing unit 153 controls arrangement of programs and data on the auxiliary storage device 113 with respect to the main storage device 112 (swap-out). In addition, the memory area releasing unit 153 updates the memory map that is stored in the main storage device 112 according to releasing of the memory area or executing of the swap-out.

[Process when Memory Area is Secured]

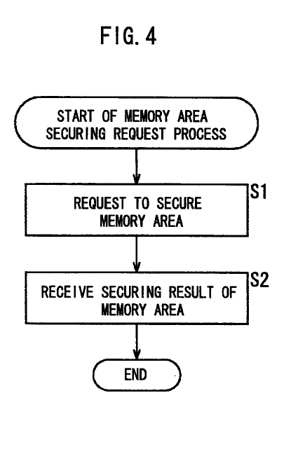

Next, processes that are executed when the area of the main storage device 112 is secured according to the request from the program 123 in the information processing system 101 will be described with reference to FIGS. 4 to 10.

### [Memory Area Securing Request Process]

First, a memory area securing request process that is executed by the program 123 will be described with reference to a flowchart of FIG. 4.

In step S1, the program 123 requests the memory area allocating unit 151 to secure the memory area. At this time, the program 123 of the request source notifies the memory area allocating unit 151 of at least a size (capacity) and a rank of the secured memory area and a rank of the program 123 of the request source.

In step S2, the program 123 receives the secured result of the memory area from the memory area allocating unit 151. The secured result of the memory area includes information indicating whether the memory area is successfully secured or not and a position of the secured memory area.

### [First Embodiment of Memory Area Securing Process]

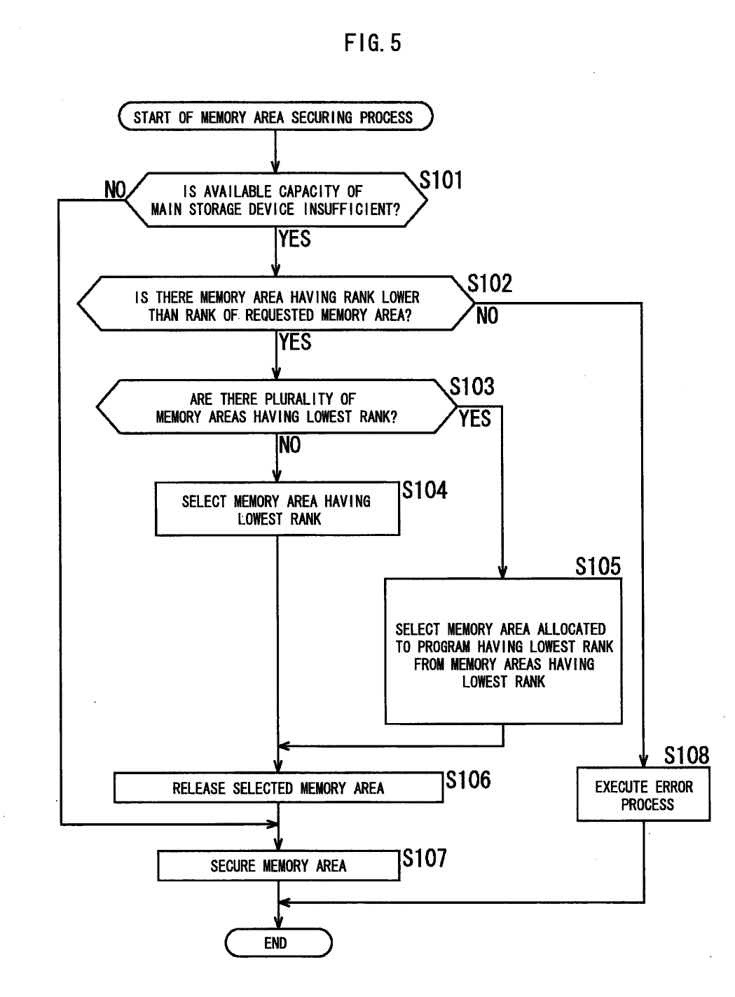

Next, a first embodiment of a memory area securing process that is executed by the memory manager 121 to correspond to the memory area securing request process of FIG. 4 will be described with reference to a flowchart of FIG. 5.

In the first embodiment, the memory area is secured preferentially using the rank of the memory area.

In step S101, the memory area allocating unit 151 determines whether or not the available capacity of the main storage device 112 is insufficient. When the main storage device 112 does not have an available capacity sufficient to perform securing of the memory area requested from the program 123, the memory area allocating unit 151 determines that the available capacity of the main storage device 112 is insufficient. In addition, the memory area allocating unit 151 notifies the memory area selecting unit 152 of information indicating that the available capacity of the main storage device 112 is insufficient, a rank of the requested memory area, and a rank of the program 123 of the request source. Then, the process proceeds to step S102.

In step S102, the memory area selecting unit 152 determines whether or not there is a memory area having a rank lower than the rank of the requested memory area. Specifically, the memory area selecting unit 152 searches the memory areas (that is, secured memory areas) allocated to each program 123 for a memory area having a rank lower than the rank of the requested memory area on the basis of the memory map. As a result, when it is determined that there is a memory area having a rank lower than the rank of the requested memory area, the process proceeds to step S103.

In step S103, the memory area selecting unit 152 determines whether or not there are a plurality of memory areas having the lowest rank. When it is determined that there is only one memory area having the lowest rank, the process proceeds to step S104. This corresponds to when there is only one memory having a low rank among the secured memory areas or when there is no memory area having a low rank and there is only one memory area having a middle rank, in the case in which the memory area requested from the program 123 has a high rank.

In step S104, the memory area selecting unit 152 selects the memory area having the lowest rank. The memory area selecting unit 152 notifies the memory area releasing unit 153 of the selected memory area.

Then, the process proceeds to step S106.

Meanwhile, in step S103, when it is determined that there are a plurality of memory areas having the lowest rank, the process proceeds to step S105.

In step S105, the memory area selecting unit 152 selects a memory area allocated to the program 123 having the lowest rank from the memory areas having the lowest rank. When the number of corresponding memory areas is plural, the memory area selecting unit 152 selects one memory area on the basis of a size or a use situation of the memory area or randomly. In addition, the memory area selecting unit 152 notifies the memory area releasing unit 153 of the selected memory area.

Then, the process proceeds to step S106.

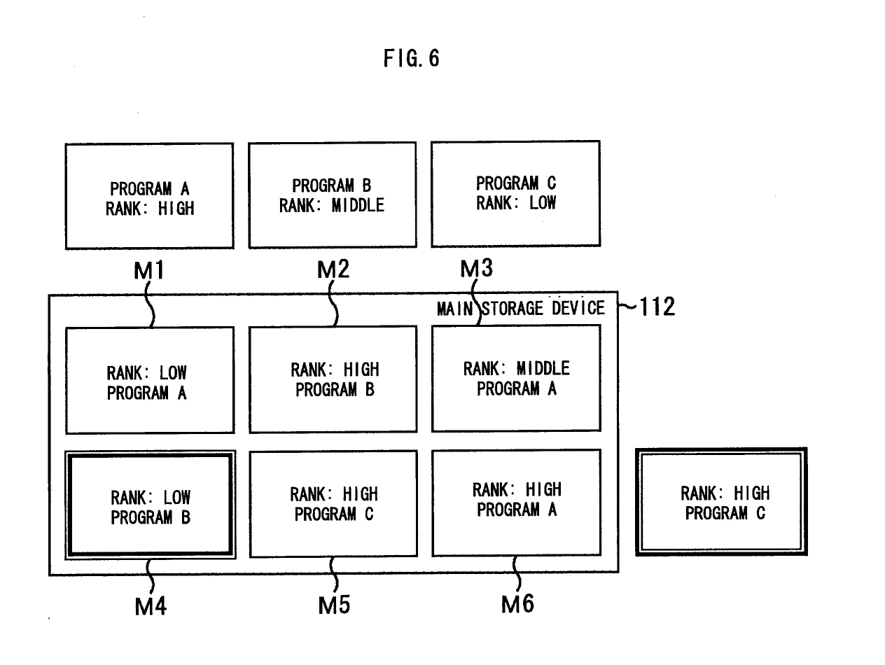

A specific example of a process of step S105 will be described with reference to FIG. 6.

In this example, 6 memory areas M1 to M6 are secured in the main storage device 112. Among the 6 memory areas, the memory areas M1, M3, and M6 are allocated to the program A, the memory areas M2 and M4 are allocated to the program B, and the memory area M5 is allocated to the program C. The memory areas M2, M5, and M6 are set to have a high rank, the memory area M3 is set to have a middle rank, and the memory areas M1 and M4 are set to have a low rank.

The program A is set to have a high rank, the program B is set to have a middle rank, and the program C is set to have a low rank.

In addition, the case in which the program C requests to secure the memory area having a high rank is examined.

In this case, the memory areas that have a middle rank and a low rank lower than the rank of the memory area requested by the program C are the three memory areas M1, M3, and M4. Among the three memory areas, the memory areas that have the lowest rank are the two memory areas M1 and M4. The program B to which the memory area M4 of the two memory areas is allocated has a rank lower than a rank of the program A to which the memory area M1 is allocated. Therefore, in this case, the memory area M4 is selected.

Returning back to FIG. 5, in step S106, the memory area releasing unit 153 releases the selected memory area. At this time, the selected memory area may be simply released and the selected memory area may be released by swapping out data of the selected memory area to the auxiliary storage device 113.

The memory area releasing unit 153 erases information of the released memory area from the memory map. The memory area releasing unit 153 notifies the memory area allocating unit 151 that the memory area is released.

Then, the process proceeds to step S107.

At this time, releasing of the memory area may be notified or may not be notified with respect to the program 123 to which the released memory area is allocated.

In the case of the former, the memory manager 121 may immediately perform an interrupt notification with respect to the program 123. For example, when the program 123 has access to the released memory area, the memory access unit 122 may perform the interrupt notification.

In the case of the latter, the program 123 may detect releasing of the memory area, on the basis of a value of the released memory area (for example, all clearing).

Meanwhile, in step S101, when it is determined that the available capacity of the main storage device 112 is sufficient, the processes of steps S102 and S106 are skipped and the process proceeds to step S107.

In step S107, the memory area allocating unit 151 secures a memory area. That is, the memory area allocating unit 151 secures a memory area having a size requested by the program 123, in an available area of the main storage device 112.

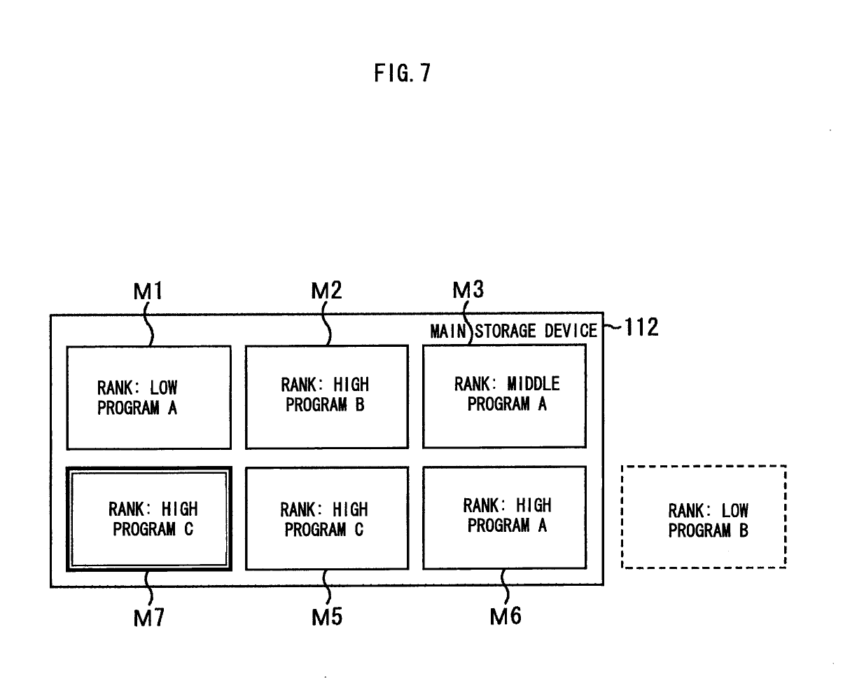

For example, in the case of the example of FIG. 6 described above, the memory area M4 is released and the memory area M7 is secured instead and allocated to the program C by the processes of steps S106 and S107, as shown in FIG. 7.

The memory area allocating unit 151 adds information indicating a position, a size, and a rank of a memory area to be newly secured and the program 123 to which the memory area is allocated and a rank thereof, to the memory map. In addition, the memory area allocating unit 151 notifies the program 123 of the request source of the position of the secured memory area.

Then, the memory area securing process ends.

Meanwhile, in step S102, when it is determined that there is no memory area having a rank lower than the rank of the requested memory area, the process proceeds to step S108.

In step S108, the memory manager 121 executes an error process. At this time, securing of the memory area may not be performed and the program 123 of the request source may be simply notified of a failure of securing of the memory area or securing of the memory area may be attempted using another method.

In the case of the latter, the memory area releasing unit 153 compulsorily terminates at least one of the programs 123 that have a rank lower than the rank of the program 123 of the request source and releases a memory area that is allocated to the program 123. The memory manager 121 executes the process from step S101 again.

Alternatively, the memory manager 121 attempts to secure the requested memory area preferentially using the rank of the program 123, similar to a second embodiment of the memory area securing process to be described below.

Then, the memory area securing process ends.

As such, when securing of the memory area is requested by the program 123, if the available capacity of the main storage device 112 is insufficient, the memory areas having lower ranks are released and new memory areas are secured. Therefore, occurrence of a situation where the information processing system 101 operates abnormally is prevented by automatically releasing the memory areas.

### [Second Embodiment of Memory Area Securing Process]

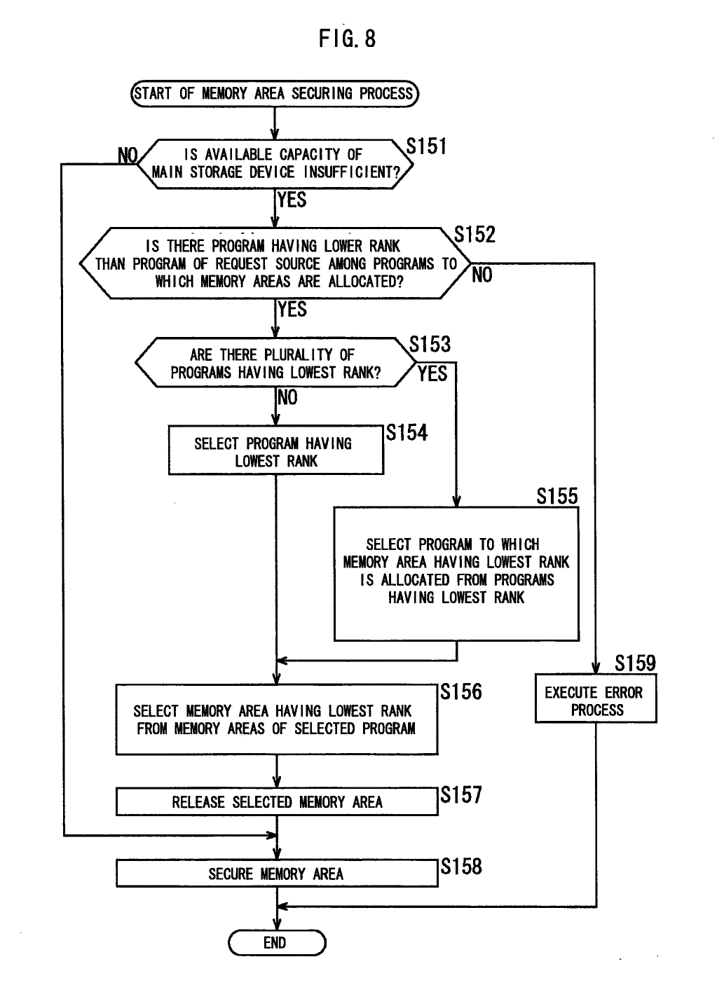

Next, the second embodiment of the memory area securing process that is executed by the memory manager 121 to correspond to the memory area securing request process of FIG. 4 will be described with reference to a flowchart of FIG. 8.

In the second embodiment, the memory area is secured preferentially using the rank of the program 123.

In step S151, similar to the process of step S101 of FIG. 5, it is determined whether or not the available capacity of the main storage device 112 is insufficient. When it is determined that the available capacity of the main storage device 112 is insufficient, the process proceeds to step S152.

In step S152, the memory area selecting unit 152 determines whether or not there is a program having a rank lower than the rank of the program 123 of the request source among the programs 123 to which the memory areas are allocated on the basis of the memory map. When it is determined that there is a program having a rank lower than the rank of the program 123 of the request source among the programs 123 to which the memory areas are allocated, the process proceeds to step S153.

In step S153, the memory area selecting unit 152 determines whether or not there are the plurality of programs 123 having the lowest rank. When it is determined that there is only one program 123 having the lowest rank, the process proceeds to step S154. This corresponds to when there is only one program having a low rank among the programs 123 to which the memory areas are allocated or when there is no memory area having a low rank and there is only one memory area having a middle rank, in the case in which the program 123 of the request source has a high rank.

In step S154, the memory area selecting unit 152 selects the program 123 having the lowest rank.

Then, the process proceeds to step S156.

Meanwhile, in step S153, when it is determined that there are a plurality of programs 123 having the lowest rank, the process proceeds to step S155.

In step S155, the memory area selecting unit 152 selects the program 123 to which the memory area having the lowest rank is allocated from the programs 123 having the lowest rank. When there are a plurality of programs 123, one program 123 is selected on the basis of a size of the memory area allocated to the program 123 or a state of the program 123 or randomly.

Then, the process proceeds to step S156.

In step S156, the memory area selecting unit 152 selects a memory area having the lowest rank from the memory areas allocated to the selected program 123. When there are a plurality of memory areas, one memory area is selected on the basis of a size or a use situation of the memory area or randomly. The memory area selecting unit 152 notifies the memory area releasing unit 153 of the selected memory area.

In step S157, the same process as the process of step S106 of FIG. 5 is executed and the selected memory area is released.

Then, the process proceeds to step S158.

Meanwhile, in step S151, when it is determined that the available capacity of the main storage device 112 is sufficient, the processes of steps S152 to S157 are skipped and the process proceeds to step S158.

In step S158, the same process as the process of step S107 of FIG. 5 is executed and the memory area is secured.

Then, the memory area securing process ends.

Meanwhile, in step S152, when it is determined that there is no program having a rank lower than the rank of the program 123 of the request source among the programs 123 to which the memory areas are allocated, the process proceeds to step S159.

In step S159, the memory manager 121 executes an error process. At this time, securing of the memory area may not be performed and the program 123 of the request source may be simply notified of a failure of securing of the memory area or securing of the memory area may be attempted using another method.

In the case of the latter, the memory manager 121 attempts to secure the requested memory area preferentially using the rank of the memory area, similar to the first embodiment of the memory area securing process of FIG. 5.

Then, the memory area securing process ends.

As such, when securing of the memory area is requested by the program 123, if the available capacity of the main storage device 112 is insufficient, the memory areas of the programs 123 that have the lower ranks are released and new memory areas are secured. Therefore, occurrence of a situation where the information processing system 101 operates abnormally is prevented by automatically releasing the memory areas.

### [Third Embodiment of Memory Area Securing Process]

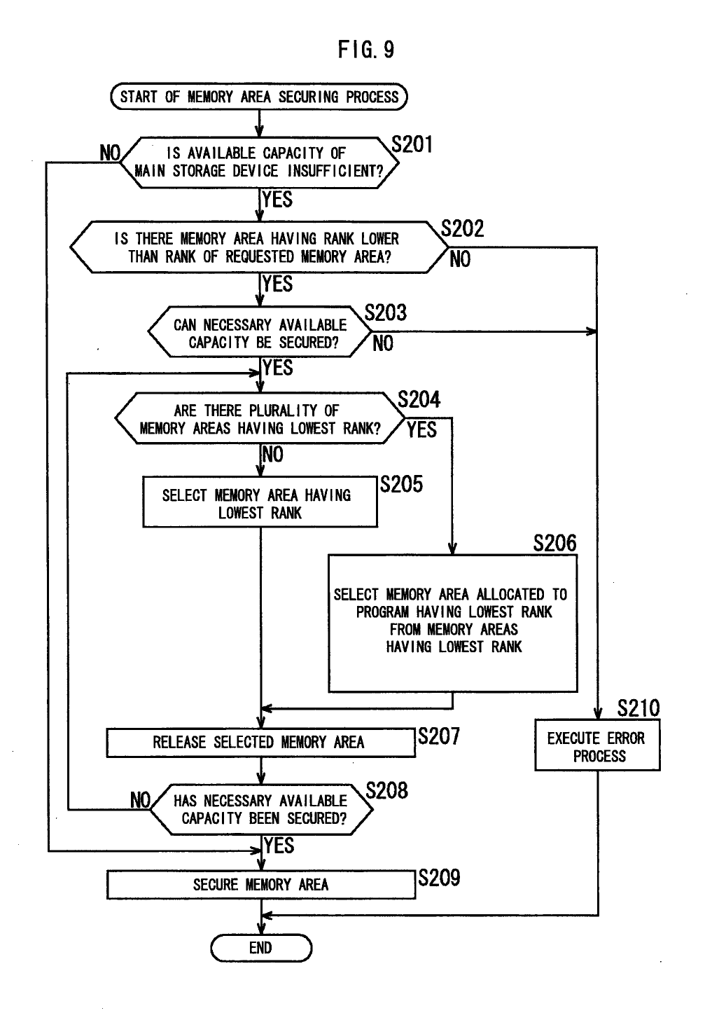

Next, a third embodiment of the memory area securing process that is executed by the memory manager 121 to correspond to the memory area securing request process of FIG. 4 will be described with reference to a flowchart of FIG. 9.

In the third embodiment, a plurality of memory areas can be released and requested memory areas can be secured when the memory areas are secured preferentially using the ranks of the memory areas, similar to the first embodiment described above with reference to FIG. 5.

In step S201, similar to the process of step S101 of FIG. 5, it is determined whether or not the available capacity of the main storage device 112 is insufficient. When it is determined that the available capacity of the main storage device 112 is insufficient, the process proceeds to step S202.

In step S202, similar to the process of step S102 of FIG. 5, it is determined whether or not there is a memory area having a rank lower than the rank of the requested memory area. When it is determined that there is a memory area having a rank lower than the rank of the requested memory area, the process proceeds to step S203.

Hereinafter, the memory areas that have a rank lower than the rank of the requested memory area in the above processes are called releasable areas.

In step S203, the memory area selecting unit 152 determines whether or not a necessary available capacity can be secured. When the available capacity of the main storage device 112 in the case in which all of the releasable areas are released reaches the capacity necessary for securing the requested memory area, the memory area selecting unit 152 determines that the necessary available capacity can be secured and the process proceeds to step S204.

Then, in steps S204 to S207, the same processes as the processes of steps S103 to S106 of FIG. 5 are executed. Thereby, one memory area having the lowest rank is selected from the releasable areas and the selected memory area is released.

In step S208, the memory area allocating unit 151 determines whether or not a necessary available capacity can be secured. When the available capacity of the main storage device 112 does not reach the available capacity necessary for securing the requested memory area, the memory area allocating unit 151 determines that it is difficult to secure the necessary available capacity and the process returns to step S204.

Then, in step S208, the processes of steps S204 to S208 are repetitively executed until it is determined that the necessary available capacity can be secured. Thereby, the individual memory areas are released sequentially from the memory areas having low ranks.

Meanwhile, in step S208, when it is determined that the necessary available capacity can be secured, the process proceeds to step S209.

In step S201, when it is determined that the available capacity of the main storage device 112 is sufficient, the processes of steps S202 to S208 are skipped and the process proceeds to step S209.

In step S209, the same process as the process of step S107 of FIG. 5 is executed and the memory area is secured.

Then, the memory area securing process ends.

Meanwhile, in step S202, when it is determined that there is no memory area having a rank lower than the rank of the requested memory area, the process proceeds to step S210.

In step S203, when it is determined that it is difficult to secure the necessary available capacity, the process proceeds to step S210.

In step S210, the memory manager 121 manages an error process. At this time, securing of the memory area may not be performed and the program 123 of the request source may be simply notified of a failure of securing of the memory area or securing of the memory area may be attempted using another method.

In the case of the latter, the memory area releasing unit 153 compulsorily terminates at least one of the programs 123 that have a rank lower than the rank of the program 123 of the request source and releases the memory area that is allocated to the program 123. The memory manager 121 executes the process from step S101 again.

Alternatively, the memory manager 121 attempts to secure the requested memory area preferentially using the rank of the program 123, similar to a fourth embodiment of the memory area securing process to be described below.

Then, the memory area securing process ends.

Thereby, as compared with the first embodiment, the necessary memory area can be more surely secured.

### [Fourth Embodiment of Memory Area Securing Process]

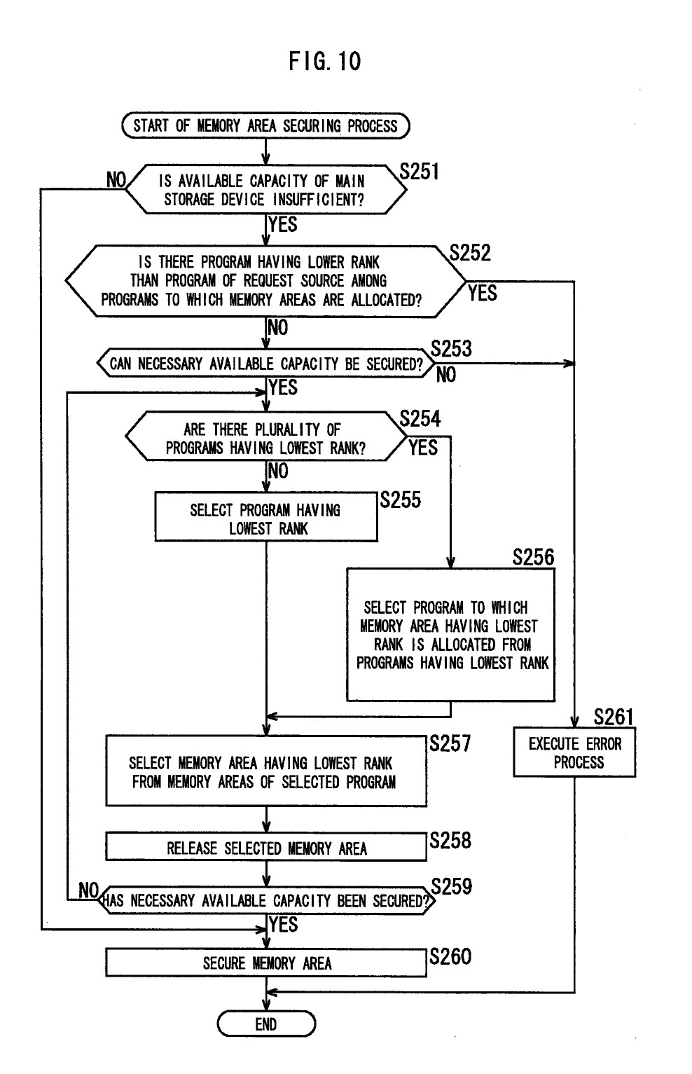

Next, the fourth embodiment of the memory area securing process that is executed by the memory manager 121 to correspond to the memory area securing request process of FIG. 4 will be described with reference to a flowchart of FIG. 10.

In the fourth embodiment, a plurality of memory areas can be released and requested memory areas can be secured when the memory areas are secured preferentially using the ranks of the programs 123, similar to the second embodiment described above with reference to FIG. 8.

In step S251, similar to the process of step S101 of FIG. 5, it is determined whether or not the available capacity of the main storage device 112 is insufficient. When it is determined that the available capacity of the main storage device 112 is insufficient, the process proceeds to step S252.

In step S252, similar to the process of step S152 of FIG. 8, it is determined whether or not there is a program having a rank lower than the rank of the program 123 of the request source among the programs 123 to which the memory areas are allocated. When it is determined that there is a program having a rank lower than the rank of the program 123 of the request source among the programs 123 to which the memory areas are allocated, the process proceeds to step S253.

Hereinafter, the memory areas that are allocated to the programs 123 having ranks lower than the rank of the program 123 of the request source in the above processes are called releasable areas.

In step S253, the memory area selecting unit 152 determines whether or not a necessary available capacity can be secured. When the available capacity of the main storage device 112 in the case in which all of the releasable areas are released reaches the capacity necessary for securing the requested memory area, the memory area selecting unit 152 determines that the necessary available capacity can be secured and the process proceeds to step S254.

Then, in steps S254 to S258, the same processes as the processes of steps S153 to S157 of FIG. 8 are executed. Thereby, one memory area having the lowest rank is selected from the memory areas allocated to the programs 123 having the lowest rank and the selected memory area is released.

In step S259, similar to the process of step S208 of FIG. 9, it is determined whether or not a necessary available capacity can be secured. When it is determined that it is difficult to secure the necessary available capacity, the process returns to step S254.

Then, in step S259, the processes of steps S254 to S259 are repetitively executed until it is determined that the necessary available capacity can be secured. Thereby, the individual memory areas are released sequentially from the memory areas allocated to the programs 123 having low ranks.

Meanwhile, in step S259, when it is determined that the necessary available capacity can be secured, the process proceeds to step S260.

In step S251, when it is determined that the available capacity of the main storage device 112 is sufficient, the processes of steps S252 to S259 are skipped and the process proceeds to step S260.

In step S260, the same process as the process of step S107 of FIG. 5 is executed and the memory area is secured.

Then, the memory area securing process ends.

Meanwhile, in step S252, when it is determined that there is no program having a rank lower than the rank of the program 123 of the request source among the programs 123 to which the memory areas are allocated, the process proceeds to step S261.

In step S253, when it is determined that it is difficult to secure the necessary available capacity, the process proceeds to step S261.

In step S261, the memory manager 121 manages an error process. At this time, securing of the memory area may not be performed and the program 123 of the request source may be simply notified of a failure of securing of the memory area or securing of the memory area may be attempted using another method.

In the case of the latter, the memory manager 121 attempts to secure the requested memory area preferentially using the rank of the memory area, similar to the third embodiment of the memory area securing process of FIG. 9.

Then, the memory area securing process ends.

Thereby, as compared with the second embodiment, the necessary memory area can be more surely secured.

### [Memory Access Process]

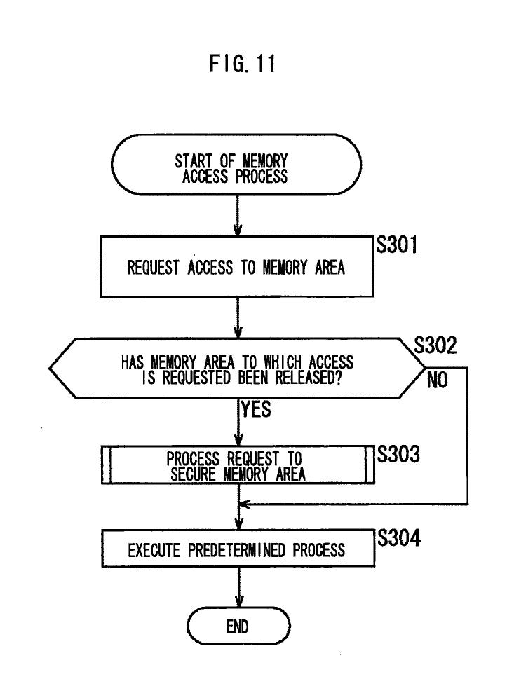

Next, a process that is executed in the case in which the program 123 has access to a released memory area when the program 123 is not notified of releasing of the memory area at the time of automatically releasing the memory area will be described with reference to a flowchart of FIG. 11.

In step S301, the program 123 requests access to a memory area (for example, read or write data) the memory access unit 122.

In step S302, the program 123 determines whether or not the access requested memory area is released. For example, the program 123 determines whether or not the access requested memory area is released according to existence or non-existence of an interrupt notification from the memory access unit 122. For example, the program 123 determines whether or not the access requested memory area is released, on the basis of whether a value of the access requested memory area is all cleared. When it is determined that the access requested memory area is released, the process proceeds to step S303.

In step S303, the program 123 executes the memory area securing request process with reference to FIG. 4.

At this time, when data of the memory area before releasing is swapped out, the data is swapped in the secured memory area.

When the data of the memory area before releasing is not swapped out, the program 123 recalculates the data of the memory area before releasing and stores the data in the secured memory area through the memory access unit 122.

Then, the process proceeds to step S304.

Meanwhile, in step S302, when it is determined that the access requested memory area is not released, the process of step S303 is skipped and the process proceeds to step S304.

In step S304, the program 123 executes a predetermined process, that is, a process involved in access of the memory area.

Then, the memory access process ends.

### <2. Modifications>

Hereinafter, modifications of the embodiments of the present disclosure will be described.

### [First Modification]

In the above description, the ranks of the memory areas and the programs 123 are classified into ranks of three steps of high, middle, and low. However, the ranks may be classified into ranks of two steps or four steps or more.

### [Second Modification]

In addition, ranks that are not permitted to automatically release the ranks by the memory manager 121 may be set as the ranks of the memory areas and the memory areas that are set to the ranks may be excluded from automatic release objects in the memory area securing process.

Similarly, ranks for which automatic release by the memory manager 121 is not permitted may be set as the ranks of the programs 123, and the memory areas allocated to the programs 123 having the ranks may be excluded from automatic release objects in the above-described memory area securing process.

### [Third Modification]

In addition, the case in which the ranks of the memory areas change during execution of the programs 123 is assumed. Therefore, the ranks of the memory areas may be dynamically changed when the memory areas are secured and according to the requests from the programs 123 during the execution of the programs 123.

For example, the case in which the ranks of the memory areas to be secured temporarily in the main storage device 112 without being released are set to high ranks when the memory areas are used and are set to low ranks when the memory areas are not used to realize a high-speed process is considered.

Thereby, the ranks of the memory areas can be appropriately set, and the memory areas having low degrees of importance can be released and new memory areas can be secured when the available capacity of the main storage device 112 is insufficient.

Similarly, the rank of the programs 123 may be dynamically changed.

### [Fourth Modification]

In the second and fourth embodiments of the memory area securing process, in the case of the memory area of the program 123 having a rank lower than the rank of the program 123 of the request source, the memory area that has a rank equal to or higher than the rank of the requested memory area may be released. In the second and fourth embodiments, the memory area that has a rank equal to or higher than the rank of the requested memory area may be excluded from the automatic release objects.

### [Fifth Modification]

In addition, the configuration example of the software of the information processing system 101 described above is exemplary and the software of the information processing system may have another configuration. For example, the program 123 may execute all or a part of the functions of the memory manager 121 and the memory access unit 122. For example, the memory manager 121 may execute all or a part of the functions of the memory access unit 122.

### [Sixth Modification]

The series of processes described above may be executed by hardware or software. For example, the memory access unit 122 may include hardware such as a memory management unit (MMU).

When the series of processes is executed by software, the program forming the software is installed on a computer. In this case, examples of the computer include a computer that is embedded in dedicated hardware and a general-purpose personal computer in which various programs can be installed and various functions can be executed.

The program that is executed by the computer can be recorded in removable media functioning as package media and may be provided. The program can be provided through wired or wireless transmission media, such as a local area network, the Internet, and digital satellite broadcasting. The program can be installed previously in a storage device (for example, auxiliary storage device 113) embedded in an apparatus.

The program that is executed by the computer may be a program that is processed temporally according to the order described in the present disclosure or a program that is executed in parallel or at necessary timing such as when calling is performed.

In the present disclosure, a terminology of the system means an entire apparatus that includes plural devices and units.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

A memory management apparatus including:

a memory area allocating unit that secures areas of a storage device according to requests from programs and sets ranks designated by the programs to the secured areas;

a memory area selecting unit that selects an area released on the basis of the rank of each area from the secured areas when an available capacity of the storage device is insufficient; and

a memory area releasing unit that releases the selected area.

(2)

The memory management apparatus according to (1),

wherein the memory area selecting unit selects an area to be released from areas having ranks lower than a rank of a newly secured area.

(3)

The memory management apparatus according to (2),

wherein the memory area selecting unit selects an area having the lowest rank among the areas having ranks lower than the rank of the newly secured area as a released area.

(4)

The memory management apparatus according to (3),

wherein the ranks are previously set to each program, and

the memory area selecting unit selects an area allocated to the program having the lowest rank among the areas having the lowest rank as the released area when there are a plurality of areas having the lowest rank.

(5)

The memory management apparatus according to any one of (2) to (4),

wherein the memory area selecting unit does not secure a new area when there is no area having a rank lower than the rank of the newly secured area.

(6)

The memory management apparatus according to any one of (2) to (4),

wherein the ranks are previously set to each program, and

the memory area releasing unit compulsorily terminates at least one of the programs having ranks lower than the ranks of the programs having requested securing of the areas when there is no area having a rank lower than the rank of the newly secured area.

(7)

The memory management apparatus according to any one of (1) to (6),

wherein the memory area allocating unit changes the ranks of the areas allocated to the programs according to the requests from the programs.

(8)

A memory management method including:

securing areas of a storage device according to requests from programs and setting ranks designated by the programs to the secured areas;

selecting an area released on the basis of the rank of each area from the secured areas when an available capacity of the storage device is insufficient; and releasing the selected area.

(9)

A control program for causing a computer to execute a process including:

securing areas of a storage device according to requests from programs and setting ranks designated by the programs to the secured areas;

selecting an area released on the basis of the rank of each area from the secured areas when an available capacity of the storage device is insufficient; and

releasing the selected area.

The present disclosure contains subject matter related to that disclosed in Japanese Priority Patent Application JP 2011-086306 filed in the Japan Patent Office on Apr. 8, 2011, the entire content of which is hereby incorporated by reference.

What is claimed is:

1. A memory management apparatus comprising:
a memory area allocating unit that secures areas of a storage device according to requests from programs and sets ranks designated by the programs to the secured areas;
a memory area selecting unit that selects an area released on the basis of the rank of each area from the secured areas when an available capacity of the storage device is insufficient; and
a memory area releasing unit that releases the selected area.

2. The memory management apparatus according to claim 1,
wherein the memory area selecting unit selects an area to be released from areas having ranks lower than a rank of a newly secured area.

3. The memory management apparatus according to claim 2,
wherein the memory area selecting unit selects an area having the lowest rank among the areas having ranks lower than the rank of the newly secured area as a released area.

4. The memory management apparatus according to claim 3,
wherein the ranks are previously set to each program, and
the memory area selecting unit selects an area allocated to the program having the lowest rank among the areas having the lowest rank as the released area when there are a plurality of areas having the lowest rank.

5. The memory management apparatus according to claim 2,
wherein the memory area selecting unit does not secure a new area when there is no area having a rank lower than the rank of the newly secured area.

6. The memory management apparatus according to claim 2,
wherein the ranks are previously set to each program, and
the memory area releasing unit compulsorily terminates at least one of the programs having ranks lower than the ranks of the programs having requested securing of the areas when there is no area having a rank lower than the rank of the newly secured area.

7. The memory management apparatus according to claim 1,
wherein the memory area allocating unit changes the ranks of the areas allocated to the programs according to the requests from the programs.

8. A memory management method comprising:
securing areas of a storage device according to requests from programs and setting ranks designated by the programs to the secured areas;
selecting an area released on the basis of the rank of each area from the secured areas when an available capacity of the storage device is insufficient; and
releasing the selected area.

9. A control program for causing a computer to execute a process comprising:
securing areas of a storage device according to requests from programs and setting ranks designated by the programs to the secured areas;
selecting an area released on the basis of the rank of each area from the secured areas when an available capacity of the storage device is insufficient; and
releasing the selected area.
